(19) United States
(12) Patent Application Publication
(10) Pub. No.: US 2003/0233228 A1
(43) Pub. Date: Dec. 18, 2003

(54) Audio coding system and method

(76) Inventor: John Michael Dahl, Grand Forks, ND (US)

Correspondence Address: John Michael Dahl, 3485 Olive Lane N., Plymouth, MN, 55447, US

(21) Appl. No.: 10/162,152

(22) Filed: Jun. 3, 2002

(51) Int. Cl. G10L 19/00

(52) U.S. Cl. 704/200.1

(57) ABSTRACT

A system and method for audio coding an audio signal are provided. In one embodiment of the invention, selected masked tones that are reduced in audibility by masking tones are discarded, and those masked tones that are reduced in audibility by a masking tone that when reproduced along with the masking tone result in a perceived difference tone are retained.

### FIELD OF THE INVENTION

The invention relates generally to audio coding, and more specifically to audio coding utilizing a psychoacoustic model of human perception to discard certain information in coding.

### BACKGROUND OF THE INVENTION

Digital audio technology utilizes digital computerized representations of analog audio signals to do things such as storing, processing, and reproducing digitized audio signals. The audio signal is typically first digitized, and the digital representation of the audio signal can be processed or stored in a digital electronic audio system. Because high-quality digitization of audio produces large amounts of digital data, storage often is performed using high-capacity devices such as computer hard disc drives, magnetic recording tape, or compact discs.

The efficiency and cost of digital audio systems is in large part dependent on the quantity of data that must be stored and processed to reproduce audible sounds. For this reason, methods of audio coding are used to reduce the amount of digitized data that must be stored to represent sound at an acceptable level of accuracy or fidelity. Such audio coding methods include both lossless coding, which results in no loss of information or reproduced audio quality, and lossy coding, which results in some degree of lost information and a subsequent reduction in sound quality. Some audio coding methods utilize both lossy and lossless coding, typically first performing a lossy coding and then performing a lossless coding of the resulting data.

Lossy coding is used despite the resultant loss in information and audio fidelity because the resulting loss of information typically results in a more efficient coding process than could be realized by performing lossless coding on the same data. To maintain a high degree of perceived audio fidelity while discarding audio signal information, lossy audio coding methods have typically employed methods that eliminate or reduce tones that are too quiet to hear, methods that eliminate or reduce tones that are masked by louder tones occurring at near times, and methods that eliminate tones that are masked by louder tones of near frequency occurring at the same time. Varying amounts of information are discarded in various implementations of lossy coding, and the effect of discarding a greater amount of information with a coding method is generally a greater reduction in perceived audio quality or fidelity.

Such lossy coding has become widely used for compression of high fidelity audio signals, including use in high-definition TV, DVD, and MP3 (Mpeg 2, layer 3) audio files commonly stored and traded via computers and other digital audio devices.

Multi-channel coding methods such as Dolby AC-3 and DTS further rely upon similar lossy audio coding to reduce the amount of data that must be stored to represent the sounds of a movie soundtrack or other multichannel audio recording.

Each of these devices stores, reads, and processes the coded audio data before it can be converted to an analog audio signal and reproduced as audio. The cost and efficiency of storing, reading, and processing the data is typically reduced if the amount of coded data is reduced, making desirable a system or method of audio coding that efficiently and accurately represents an audio signal.

### SUMMARY OF THE INVENTION

A system and method for audio coding an audio signal are provided. In one embodiment of the invention, selected masked tones that are reduced in audibility by masking tones are discarded, and those masked tones that are reduced in audibility by a masking tone that when reproduced along with the masking tone result in a perceived difference tone are retained.

### BRIEF DESCRIPTION OF THE FIGURES

FIG. 1 shows a diagram representing frequency components that may be discarded during audio coding consistent with an embodiment of the present invention.

FIG. 2 shows a flowchart illustrating coding and decoding of an audio signal, consistent with an embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides an improved audio coding system and method that efficiently and accurately codes an audio signal. In one embodiment of the invention, tones that are themselves masked by other tones are not discarded but are retained if it is determined that a difference tone is perceived when the masked and masking tones are reproduced.

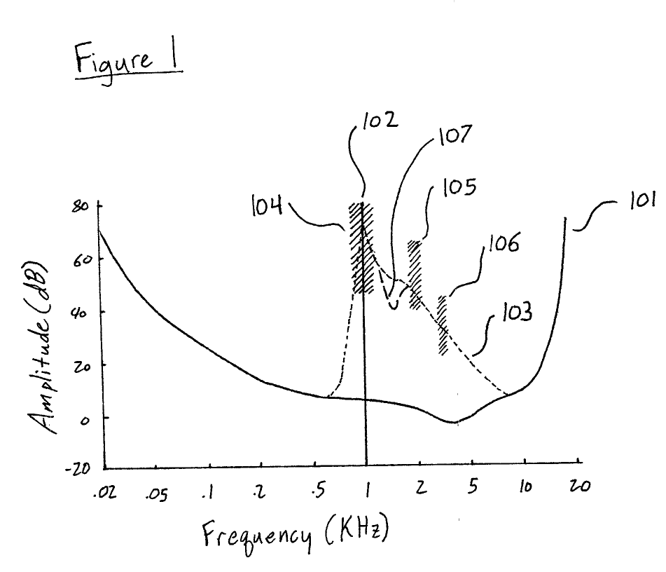

FIG. 1 illustrates one example of how various tones, including difference tones and masked tones, are perceived. The graph shows various phenomena in graphical form, plotted on a graph of amplitude in deciBels versus frequency in kiloHertz. Curve 101 represents the amplitude in deciBels of an audio tone at various frequencies that is just perceivable by the human ear. Tones above the perceivable tone curve 101 are therefore perceivable, and tones below the curve are not perceivable.

The 80 dB tone at 102 is in this example a masking tone that will be used to illustrate phenomena such as masking, beat tones, and difference tones. Here, the masking tone 102 masks, or renders inaudible, those tones that are below the masking curve 103. Much of the area under the masked tone curve 103 is above the perceivable tone curve 101, but the tones between these curves are not perceivable because the masking tone 102 renders these masked tones inaudible despite their amplitude.

The hashed region 104 represents a region wherein tones produced in addition to a masking tone will produce audible beat tones. That is, the tones that are themselves under the masking curve 103 but are within the hashed region 104 will not themselves be heard, but will produce beat tones that are perceivable. Similarly, the hashed region 105 is centered around twice the frequency of the masking tone 102, and tones in this range in combination with the masking tone may also produce audible beat tones. A third hashed region centered around a region three times the frequency of the masking tone 102 is found at 106, wherein beat tones may also be produced. It is significant to note that tones in regions 104, 105, and 106 that are below the masking curve 103 are not themselves audible in the presence of masking tone 102, but may produce audible artifacts in combination with masking tone 102.

A difference tone curve 107 lies below the masking curve 103, and the area between difference tone curve 107 and masking curve 103 represents an area within which tones are not themselves audible in the presence of masking tome 102, but that can produce in combination with masking tone 102 an audible difference tone. A difference tone is different in nature from the beat tones discussed previously in that the difference tone is a phenomenon that is not measurable with instrumentation but is a distortion produced within the human ear. For example, when combined with the masking tone 102 at 1 kHz, test tone frequencies near 1.4 kHz can produce difference tones near 600 kHz through nonlinear distortion in the human ear.

The difference tones produced by two primary tones, one at a lower frequency f1 and one at a higher frequency f2, can occur at frequencies f2−f1, f2+f1, 2f1−f2, 2f2−f1, and to a lesser extent at other frequencies. Hearing tests can reveal the audibility of various difference tones, as well as the audibility of beat tone regions and masked tone curves as are shown in FIG. 1 for masking tones of different frequencies and amplitudes. Audibility of various tones and artifacts may be determined in various methods in different embodiments of the invention, including average levels of audibility, audibility to the most perceptive test subjects, audibility to a certain percentage of people, or via other methods. Once it is determined by these methods which tones are sufficiently reduced in audibility by a masking tone that they may be considered inaudible and which tones produce audible artifacts in the presence of a masking tone, a psychoacoustic model such as that shown in FIG. 1 may be produced for a masking tone of a given amplitude and frequency.

Because masked tones that are lower in amplitude than the traditional masked tone curve 103 of FIG. 1 can produce audible artifacts through difference tones and beat tones, certain tones that are themselves not audible because they are masked by a masking tone will in combination with the masking tone produce an audible artifact. One embodiment of the present invention applies these facts to audio coding by discarding selected masked tones that are reduced in audibility by masking tones, but retaining those masked tones that are reduced in audibility by a masking tone that when reproduced along with the masking tone result in a perceived difference tone. In a further embodiment of the invention, tones that are reduced in audibility by a masking tone that when reproduced along with the masking tone result in a perceived beat tone are also retained, and are not discarded as the masked tone curve alone suggests they could be.

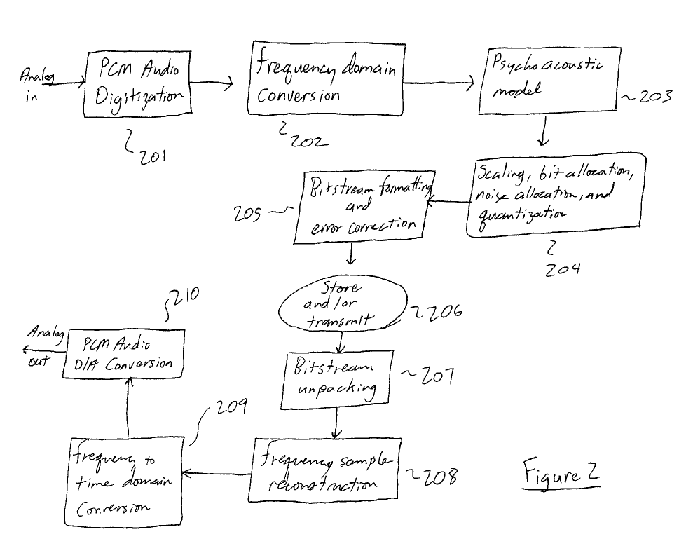

Retaining masked tones that contribute to production of difference tones and beat tones ensures that these beat and difference tone artifacts that are perceivable in an audio signal will be perceivable in a reproduced audio signal, and not discarded because of the inaudibility of a masked tone. A more detailed explanation of audio coding consistent with an embodiment of the present invention is illustrated in FIG. 2.

An analog audio signal is received in a digitization module at 201, where the analog audio signal is converted to a pulse code modulated digital audio signal. The digital audio signal is converted to a frequency domain signal at 202, and a psychoacoustic model is applied to the frequency domain signal at 203. The psychoacoustic model includes in various embodiments of the invention characterization of masked tone curves, beat tone regions, and difference tone regions for tones of various frequencies and amplitudes such as are illustrated in FIG. 1.

After application of the psychoacoustic model, the digital audio signal is scaled, and undergoes various other processes such as bit allocation, noise allocation, and quantization at 204. The resulting signal has bitstream formatting and error correction applied at 205, and is stored or transmitted at 206. The stored or transmitted digital audio signal may in some embodiments of the invention include transmission, such as through a digital radio, digital television system, or through the Internet, and in other embodiments of the invention will include digital storage, such as storage on a DVD, on a compact disc, or as a computer file.

The transmitted or stored signal is received and the bitstream is unpacked or decoded at 207. The unpacked signal undergoes frequency sample reconstruction at 208, and is converted from a frequency domain signal to a time domain signal at 209. The resulting time domain digital audio signal is converted to an analog audio signal with a digital to analog converter at 210, and an analog audio signal is provided as an output.

In further embodiments of the invention, the coding elements of the present invention may include coding via a subband coder, adaptive transform coder, or a hybrid coder. Subband coders break an audio signal into a number of subbands of different frequencies, according to the human ear's hearing sensitivity characteristics. Subband coders typically feed an audio signal into a set of bandpass filters configured in contiguous frequency bands, and typically use 32 frequency bands or more depending on the desired fidelity and resolution. MPEG-1 is an example of a subband coding system, and employs 32 subband filters.

Adaptive transform coders operate similarly, but use a discrete transform, such as a discrete Fourier transform or a discrete cosine transform to convert the audio signal to a frequency domain signal. Dolby digital is an example of an adaptive transform coder, and uses from 64 to 256 spectral components.

Hybrid coders typically use several hundred spectral components or transform coefficients, with the number again determined based on the desired resolution or fidelity. Hybrid coders utilize a combination of subband and adaptive transform coding methods that allow closer tailoring of coding to human hearing characteristics, such as providing higher frequency resolution at lower frequencies. Examples of hybrid coders include MPEG-2 coders, one component of which is MPEG-2 layer 3, commonly known as MP3 and used in computerized digital audio files and portable audio players.

The present invention may also be adapted in various embodiments to multi-channel audio, such as to a stereo audio system or to a multi-channel system such as a 5.1 channel surround sound audio system. The coded audio signal of the present invention may also be combined with a video signal, such as in computerized multimedia files, digital television, or digital movie formats.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

I claim:

1. A method of coding an audio signal, comprising:
discarding selected masked tones that are reduced in audibility by masking tones; and
retaining those masked tones that are reduced in audibility by masking tones and that when reproduced along with the masking tones result in audible difference tones.

2. The method of audio coding of claim 1, wherein the discarded masked tones are rendered inaudible by the masking tones.

3. The method of audio coding of claim 1, further comprising discarding selected masked tones that are reduced in audibility by temporal masking tones.

4. The method of audio coding of claim 3, wherein the discarded selected masked tones reduced in audibility by temporal masking tones are rendered inaudible by the temporal masking tones.

5. The method of audio coding of claim 1, further comprising transforming the audio signal to a frequency spectral signal with a subband coder, an adaptive transform coder, or a hybrid coder.

6. The method of audio coding of claim 1, further comprising performing lossless compression on the coded audio signal.

7. The method of audio coding of claim 1, further comprising retaining those masked tones that are reduced in audibility by masking tones that when reproduced along with the masking tones result in audible beat tones.

8. A machine-readable medium with instructions stored thereon, the instructions when executed on a computerized system operable to cause the computerized system to code an audio signal by:
discarding selected masked tones that are reduced in audibility by masking tones; and
retaining those masked tones that are reduced in audibility by masking tones and that when reproduced along with the masking tones result in audible difference tones.

9. The machine-readable medium of claim 8, wherein the discarded masked tones are rendered inaudible by the masking tones.

10. The machine-readable medium of claim 8, wherein the instructions are further operable to cause the computerized system to discard selected masked tones that are reduced in audibility by temporal masking tones.

11. The machine-readable medium of claim 10, wherein the discarded selected masked tones reduced in audibility by a temporal masking tone are rendered inaudible by the temporal masking tones.

12. The machine-readable medium of claim 8, wherein the instructions are further operable to cause the computerized system to transform the audio signal to a frequency spectral signal with a subband coder, an adaptive transform coder, or a hybrid coder.

13. The machine-readable medium of claim 8, wherein the instructions are further operable to cause the computerized system to perform lossless compression on the coded audio signal.

14. The machine-readable medium of claim 8, wherein the instructions are further operable to cause the computerized system to retain those masked tones that are reduced in audibility by a masking tone that when reproduced along with the masking tone result in an audible beat tone.

15. A computerized audio coding system for coding an audio signal, the system operable to:
discard selected masked tones that are reduced in audibility by masking tones; and
retain those masked tones that are reduced in audibility by a masking tone that when reproduced along with the masking tone result in an audible difference tone.

16. The computerized audio coding system of claim 15, the system further operable to discard selected masked tones that are reduced in audibility by temporal masking tones.

17. The computerized audio coding system of claim 15, the system further operable to perform lossless compression on the coded audio signal.

18. The computerized audio coding system of claim 15, the system further operable to retain those masked tones that are reduced in audibility by masking tones that when reproduced along with the masking tones result in audible beat tones.

19. A method of coding and audio signal, comprising:
discarding selected masked tones that are reduced in audibility by temporal masking tones;
discarding selected masked tones that are reduced in audibility by masking tones;
retaining those masked tones that are reduced in audibility by masking tones that when reproduced along with the masking tones result in audible beat tones; and
retaining those masked tones that are reduced in audibility by masking tones and that when reproduced along with the masking tones result in audible difference tones.
